(19) United States
(12) Patent Application Publication
(10) Pub. No.: US 2005/0183142 A1
(43) Pub. Date: Aug. 18, 2005

(54) Identification of Trusted Relationships in Electronic Documents

(76) Inventor: Michael Podanoffsky, Hudson, NH (US)

Correspondence Address: MICHAEL PODANOFFSKY, 25 ST. ANTHONY DRIVE, HUDSON, NH, 03051, US

(21) Appl. No.: 10/708,230

(22) Filed: Feb. 18, 2004

(51) Int. Cl. G06F 11/30; H04L 9/32

(52) U.S. Cl. 726/18; 713/155

(57) ABSTRACT

The invention relates to the fields of computer program security, user access control, user interface methods, and online authentication, and more specifically to the field of authentication and private key management.

### BACKGROUND OF INVENTION

Electronic Mail (email) is a common way to correspond. One prevalent standard for the exchange of email is based on SMTP, the Simple Mail Transport Protocol. Internet protocols and standards are documented by the Internet Engineering Task Force (IETF) Request For Comments (RFC) process and can be accessed at www.ietf.org. SMTP is defined in IETF RFC 821, (http://www.ietf.org/rfc/rfc821.txt) which is hereby incorporated by reference in its entirety.

The technique for formatting and sending email is well known to those practiced in the art and only a brief outline is given here. Email, as defined in IETF RFC 821, relies on a plain text header containing TO, FROM, and SUBJECT lines, followed by the body of the email. Optionally, REPLY-TO, CC, and BCC lines may also be used. There is no requirement that the sender place their actual email address in the FROM line. This technique is called spoofing or forging the email address. It is a fairly common technique used by business. It permits a third-party service to mass mail advertising or newsletters. It has also led to the practice of sending mass numbers of unsolicited mail know as Spam. The SMTP protocol provides no reliable way to identify or verify the sender.

The body section of an email is formatted as either plain text or using the Multipurpose Internet Mail Extensions (MIME) extensions. MIME is defined in IETF RFC 1521 (http://www.ietf.org/rfc/rfc1521.txt), which is hereby incorporated by reference in its entirety. HTML (HyperText Markup Language) is one of several possible MIME types.

HTML, defined in IETF RFC 1866 and 1867, (http://www.ietf.org/rfc/rfc1866.txt and http://www.ietf.org/rfc/rfc1867.txt, respectively) which are hereby incorporated by reference in its entirety, is a common markup language used on the Internet for electronic mail, web pages, and other electronic documents. HTML utilizes embedded codes within a body of text to describe how text should be displayed. Those codes describe font style, size, text attributes such as underline and bold, the location and size of images, and the position of headers and columns.

One central feature of HTML is a hypertext link. Hypertext links have two parts, a display and a reference portion. The display portion can be an image, word or phrase. The reference portion contains a web address, also known as the hypertext reference, consisting of a URL (Uniform Resource Locator). Using a pointing device on a computer, such as a mouse, touch pad, or other device(s), a user clicks on the display portion of the hypertext link to be connected to the web server addressed in the reference portion of the hypertext link.

One notable feature of a hypertext link is that the display and reference portions need not bear any relationship to each other. For example, it is possible for a word such as “ugly” to be linked to a web page displaying a dress, or for a picture of a cat to be linked to a magazine subscription page. The relationship between the displayed portion and the reference portion is arbitrary. FIG. 1 (PRIOR ART) is an example of a hypertext link as used in HTML. The hypertext markup language (HTML) text shown as 101 contains a link that has both a displayed portion (102) and a reference portion (103).

A deceptive practice has evolved that combines hypertext links with the unverifiable nature of email. A recipient receives an email whose FROM address is forged or spoofed. The address is made to appear as if it is from a source the email recipient would trust but is in fact from someone they do not know and may not trust. Within the email body is an intentionally deceptive hypertext link. When clicked, it will open a web page of the sender's choosing, such as one the sender controls on one of their systems. The user is made to believe that the web page belongs to a source they trust, but is in fact from someone they do not know or trust who will solicit personal information such as account numbers, users ids, and passwords. The range of possible uses of this deceptive practice goes far beyond revealing personal information.

FIG. 2 (PRIOR ART) depicts an example of this practice. An email (201) with a FROM address that makes it appear to have originated from sender that the recipient would trust (202), containing a hypertext link (203) where the display portion is designed to makes it appear to represent the spoofed sender's business (204), but in fact contains a reference to someone else's web site (205). The link can open a page that solicits personal information such as account name and password.

A large part of the attractiveness in using this deceptive practice is that users have become conditioned to enter account names and passwords whenever asked. Users may inadvertently enter this information to a wrong or unauthenticated site before they realize their mistake.

Using techniques well known to those practiced in the art, a hypertext link can be encoded in ways that would make it exceptionally difficult for a casual user to detect that the reference portion of a link is deceptive.

There are established and well-known mechanisms to authenticate and validate both contents of an email and its sender. One such method is for a sender to digitally sign their email. Digital signatures are based on public/private keys (PK) disclosed in U.S. Pat. No. 4,405,829, which is hereby incorporated by reference in its entirety. The algorithm is also known as RSA encryption. Public/private keys are a pair of mathematically matched keys of arbitrary length. One attribute of these keys is that a message encrypted with one of the keys in the pair can only be decrypted with the other key. It is the intention that one of the keys would be public and would be published and distributed widely, while the other would be very closely guarded as a private key.

Public/private keys are used to both encrypt and sign messages. The sender can encrypt a message using the recipient's public key. Only the recipient has the matching private key and is the only one able to decrypt and read the message. To sign a message a sender could encrypt the message using their private key. Any reader can decrypt it using the sender's public key.

Another system is called Digital Signature Algorithm (DSA). This method was disclosed in U.S. Pat. No. 5,231,668, which is hereby incorporated by reference in its entirety. DSA passes the message through a hashing algorithm to produce a message digest. The sender encrypts or signs the message digest using their private key. Any recipient can verify the message digest using the sender's public key.

In order to use public/private keys, every sender and recipient would have to know each other's public key. Keys would either have to reside in a trusted public directory or be exchanged by email. A number of practical issues arise in using public keys. Among them, several businesses and/or individuals can have very similar or identical names making locating the right public key difficult.

To overcome these limitations, certificates were defined. This was disclosed in U.S. Pat. No. 5,214,702, which is hereby incorporated by reference in its entirety. A certificate contains the identity (name) of an individual or entity and their respective public key. Certificates are issued by a trusted third-party called the Certificate Authority (CA). The premise is that the Certificate Authority performs a background or other checks before the certificate is issued. It should be noted that it is entirely possible and proper for valid certificates to be issued to different companies with very similar names. A recipient has no basis for specifically trusting a signed email. The signor may not represent someone they trust, or would trust.

Signed email is based in S/MIME, Secure/Multipurpose Internet Mail Extensions, defined in IETF RFC 2311 (http://www.ietf.org/rfc/rfc2311.txt), which is hereby incorporated by reference in its entirety. In somewhat of an oversimplification, S/MIME adds a MIME data type to the email that contains a signature and the sender's public key, either in a certificate or by itself. The recipient can conclude that the sender signed the email if the computed signature of the document matches the signature in the MIME data block. The sender's public key or certificate is required. Signed email only guarantees that at one time the sender had a specific email address and a matching certificate. It does guarantee that the sender is a party that the recipient trusts, or would trust.

To demonstrate the problem of trust further, certificates are used when establishing a Secure Socket Layer (SSL) connection. SSL was disclosed by Netscape and is available at http://home.netscape.com/eng/ssl3/, which is hereby incorporated by reference in its entirety. SSL connections are encrypted and therefore secure. In the protocol, a client initiates a connection to a server (or other party) and expects to receive a certificate to validate the connection. So long as the certificate is valid, has not expired and comes from a Certificate Authority the application trusts, the SSL connection will succeed. There is no manual confirmation in the process and so a user could be connected to a server with a valid certificate but not be connected to a server they trust.

Even with a manual examination of a certificate it is impossible to determine whether a certificate was issued to an entity the recipient trusts. For example, Citibank owns the servers at www.citibank.com, but what about a server at www.citibank.co.uk, www.citibank.biz, or www.citibank.secure.hk? It is possible for any one of these servers to have valid certificates, but not be a party the user trusts.

Other mechanisms for establishing trust between a sender and a recipient have been attempted. For example, Verisign (verisign.com), TrustE (truste.com), and GeoTrust (geotrust.com) are certificate authorities that provide an electronic seal or image that a sender or entity can be attached to an email or web site that serves as a hypertext link to the certificate authority to verify or disclose information about each sender. A similar method is described in U.S. Patent Application No. 20040015699. These are all recognized herein as examples of prior art and are hereby incorporated by reference in their entirety.

The method described in the preceding paragraph can be spoofed and is not reliable. A sender, pretending to be a trusted party such as a bank or government institution, can place the trusted party's electronic seal or image by simply copying the graphic image together with a hypertext link to any web site of their choosing, completely bypassing any trust the seal may provide.

What is missing is a method for determining whether a specific email or hypertext link is from someone a user has established a trust relationship and therefore trusts. Individuals trust entities with whom they have established a trust relationship, such as their bank, investment institutions, certain commercial web sites, and so on.

In the preferred embodiment of the invention, a user, and more generally any client system, can definitively determine which electronic documents, emails, and hypertext links are from someone they trust.

Specifically, the invention provides: (1) A method for establishing a trust relationship between individuals and entities; (2) A method for definitively determining if a document or email is signed by a trusted party without requiring manual examination of keys or certificates; (3) A method for establishing a secure authenticated connection to a trusted party; (4) A method for rejecting a connection to non-trusted parties; and (5) A method for storing and retrieving information about trusted relationships in an encrypted password protected database.

### SUMMARY OF INVENTION

The invention stores information about trusted relationships in an encrypted password protected database called the Trusted Keys Vault (“Vault”). A user accepts a trust record when a trusted relationship is established. The trusted relationship information allows a user to connect to a trusted party's server and exchange keys. There will never be a need to enter other authorization information such as account names or passwords.

When a signed document or email is received, the recipient can check to determine if the signature is valid. If it is, a further check can be made to determine if the public key of the sender is in the Trusted Keys Vault. If it is, the sender is trusted.

In a preferred embodiment of the invention, both parties in a trusted relationship store each other's public keys. If one of the parties does not have a public key, a pair of public/private keys is securely created for this relationship. This permits both parties to mutually authenticate each other in email or when a user connects to a web server, eliminating the use of account numbers and passwords. Account numbers and passwords are inherently less secure than public/private keys.

A method for distributing public keys is to encode a public key or certificate and other information in a signed text message that is stored as part of an image. This information is referred to as an Identity Block (IB). It consists of two parts, a public and a private portion. The entire image, including the identity block, is signed using the sender's private key and can be checked using the sender's public key. The signature can be checked using the Trusted Keys Vault to determine if the party is trusted.

The Identity Block is not steganographically encoded in the image. Rather, it is part of the visible portion of the display. It is easily recognized as random color pixels within the image as the sequence of bytes in the Identity Block does not represent any known image.

One property of the image is that it can be “dragged and dropped” using conventional pointing devices on a computer. In the preferred embodiment of the invention, a user drags-and-drops the image from an email, web page, or other electronic document to the Trusted Keys Vault. This is one of several possible actions that can be used to verify whether the party is trusted. It can then optionally also allow a user to initiate a connection to the trusted party's web server. The Identity Block is not a digital certificate. It is not generated by a Certificate Authority and does not presume to identify the sender by name.

It will be appreciated by those skilled in the art that although the following Detailed Description will proceed with reference being made to illustrative embodiments and methods of use, the present invention is not intended to be limited to these embodiments and methods of use. Rather, the present invention is of broad scope and is intended to be defined as set forth in the accompanying claims.

### BRIEF DESCRIPTION OF DRAWINGS

The following detailed description when taken in conjunction with the figures presented herein provides a complete disclosure of the invention.

FIG. 1 (PRIOR ART) depicts an example of a hypertext link in HTML with both display and link references.

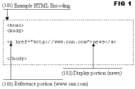

FIG. 2 (PRIOR ART) depicts an example of deceptive practice using a spoofed email address to link to a web site that solicits user account names and passwords.

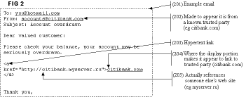

FIG. 3 depicts a generalized computing platform architecture, such as a personal computer, server computer, personal digital assistant, web-enabled wireless telephone, or other processor-based device.

FIG. 4 shows that the Trusted Keys Vault consists of two components, the Vault Storage and the Vault Manager.

FIG. 5 shows the information each record must have to maintain and recognize a trusted relationship.

FIG. 6 shows the fields that are required in the Identity Block.

FIG. 7 is an example of an image with encoded data stored along one edge of the image. The encoded information can be stored anywhere within the image.

FIG. 8 shows how the Identity Block is encoded into an image.

### DETAILED DESCRIPTION

The Trusted Keys Vault (“Vault”) is preferably realized as a feature or addition to the software already found present on well known computing platforms. These common computing platforms can include servers, personal computers, personal digital assistants (PDA), web-enabled wireless telephones, and other types of personal information management (PIM) devices.

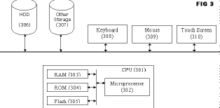

It is useful to review a generalized architecture of a computing platform that may span the range of implementation. FIG. 3 presents a generalized computer system architecture including a central processing unit (CPU) (301), which is typically comprised of a microprocessor (302) associated with random access memory (RAM) (303) and read-only memory (ROM) (304). Such a system may contain storage devices such as programmable FlashROM (305), hard disk drives (HDD) (306), and other local storage devices (307), both removable and non-removable. Additionally, some storage drives may be accessible over a computer network. The computing platform is also usually provided with one or more user input devices, such as a keyboard or a keypad (308), mouse or pointer device (309), and/or a touch-screen display (310).

It will be readily recognized by those skilled in the art that the following methods and processes may be alternatively realized as hardware functions, in part or in whole, without departing from the spirit and scope of the invention.

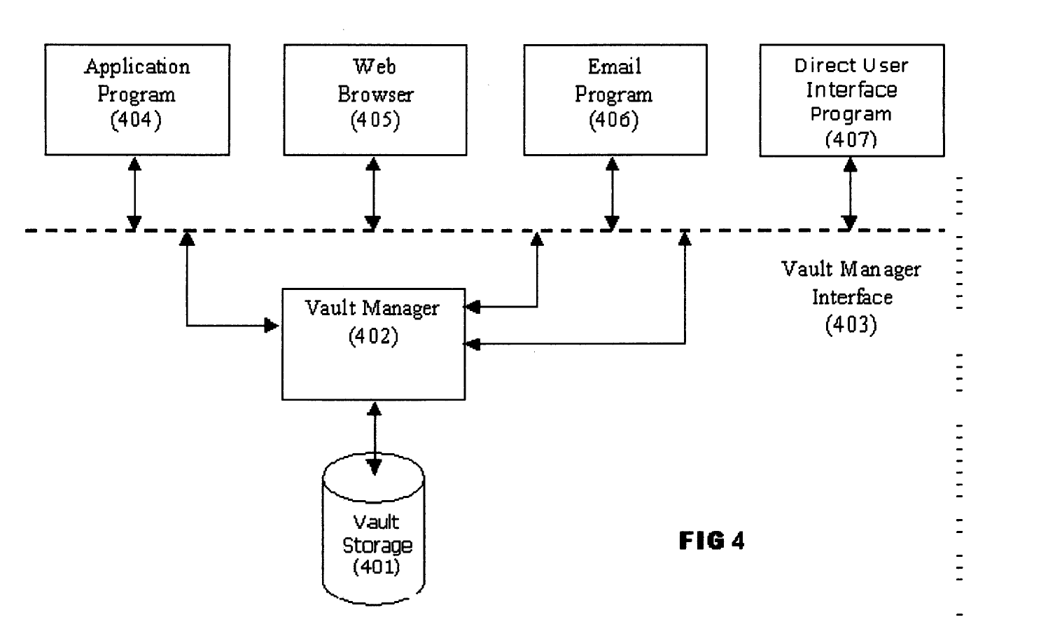

The invention stores information about trusted parties in an encrypted password protected database called the Trusted Keys Vault (“Vault”). The arrangement according to the present invention is shown in FIG. 4. The Vault consists of two components: the Vault Storage (401) and the Vault Manager (402). The Vault Manager (402) provides a programming interface for application access and controls all access to Vault Storage (401). The Vault Manager must at minimum be responsible for password protecting the Vault Storage, encrypting and decrypting the Vault Storage contents, adding and removing entries in the database, validating whether specific public keys are in the trusted database, and initiating a secure connection to a trusted site. Other services are optional and are not precluded by the invention.

Continuing with FIG. 4, application programs (404), web browsers (405), and email programs (406) may be modified or extended to interface (403) to the Vault manager (402). The Vault manager (402) may access the Vault Storage (401), an encrypted password protected database file. A Vault direct user interface program (407) may also be provided to allow the user to directly access the Vault storage (401) using the Vault manager (402) without using an application program (404), web browser (405), or email program (406).

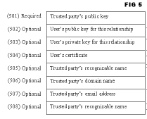

FIG. 5 shows the information stored in the Vault Storage for each trusted party. Each record represents a logical entity of related information that may comprise of one or more rows and one or more tables in the database. The record consists of the trusted party's public key (501). The record may also include the following optional information: (502) this user's public key for this relationship, (503) this user's private key for this relationship, (504) this user's certificate generated by the trusted party, (505) trusted party's recognizable name, (506) trusted party's domain name, (507) trusted party's email address, and (508) trusted party's contact information.

The invention provides a method for distributing public keys in an encoded graphical image. The key is embedded into a text message called an Identity Block (IB) that is then encoded into a graphical image. The encoded graphical image with the Identity Block is called an Identity Seal (IS). The purpose of the identity block is to sign a document, such as an email.

A user should be able to determine if a document containing an Identity Seal is valid and whether it comes from a trusted party. In the preferred embodiment of the invention, the document is “dragged-and-dropped” to the Trusted Keys Vault Manager. The document signature of the document is computed and is compared with the signature in the identity block. If valid, the public key within the identity block is checked to determine if it comes from a trusted party by matching it with a trusted party record in the Vault Storage (see FIG. 4, item 401). In this way, it is possible to identify a document as both valid and to have been created by a known specific identifiable trusted party. In accordance with the capabilities already noted for the Trusted Keys Vault Manager, a user can initiate a connection to the trusted party's web server. The drag-and-drop operation, together with the validation of the document, replaces a hypertext link as the method to connect to a party's web server.

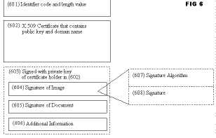

Turning to FIG. 6, the basic layout of the Identity Block is shown. It begins with (601) an identifier code and a length value of the entire Identity Block. This is followed by an X.509 certificate that contains a public key (602) signed by a recognized Certificate Authority. A certificate is composed of several fields, not individually shown, among which include a public key and a domain name. The remainder of the Identity Block (603) is signed with the private key that corresponds to the public key in the certificate in (602). Within the (603) section is a signature for the entire Identity Seal (604), a signature for the document or email (605), followed by optional additional data (606). In the preferred embodiment of the invention, fields (604) and (605) contain both the signature algorithm (607) and signature (608).

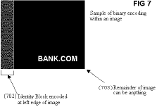

FIG. 7 shows an example of an image with an encoded text message. In this embodiment, the text message is stored along the left edge of the image, using the column-ordering method described in the next several paragraphs. The image consists of an embedded text message section along the left edge (702) and the remainder of the image (703). It will be appreciated by those skilled in the art that the embedded text message can be of any length that can be placed anywhere within the image. The size of the image must be sized to meet the length of the embedded text message.

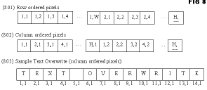

FIG. 8 shows how the identity block is encoded into an image. The identity block is not steganographically hidden within the image. Rather, the ordered set of bytes comprising the identity block overwrites specific pixels of the image. Images are encoded in one of several industry standard formats such as JPEG, GIF, PNG, and BMP. Each of these formats differs in how they compress the image and represent pixels. Regardless of their internal formats, all images can be unpacked into one or more rows, each comprised of one or more columns. The size of the image is represented by the total number of rows, known as the height (H), and the total number of columns, known as the width (W). A pixel can be of any size and can represent anywhere from a single bit to as many as 24 or more bits. Common pixel arrangements are 4, 8, and 24 bit combinations.

FIG. 8 shows the pixel arrangement in memory when expanded into an ordered list of pixels in either row order (801) or column order (802). The top left most pixel of an image is located at row 1, column 1. This can be expressed as pixel (1, 1), or more generally as (row, column). To lay out pixels by row order, all of the pixels in the first row are laid out in memory one after the other starting with the left most column pixel, followed by the second most column pixel and so on until the pixel in the last column of the first row. This is followed by the pixels in the next row, and so on until the last row is expanded. As shown in FIG. 6, row ordering (801) places the pixels for the first row in the following order (1, 1), (1, 2), (1, 3), . . . (1, W). This is then followed immediately by the pixels for the second row in the order (2, 1), (2, 2), (2, 3), . . . (2, W). All of the rows are expanded until the last row, which is place in order (H, 1), (H, 2), (H, 3), . . . (H, W).

Continuing with FIG. 8, column ordering (802) places the pixels for the first column in the following order (1, 1), (2, 1), (3, 1), . . . (H, 1). This is then followed immediately by the pixels for the second column in the order (1, 2), (2, 2), (3, 2), . . . (H, 2). All of the column are expanded until the last column, which is place in order (1, W), (2, W), (3, W), . . . (H, W).

Diagram (803) shows how a simple sample text message such as “TEXT OVERWRITE” maps to specific pixels. The example uses column ordering. The first affected pixel starts at row 1, column 1 (1, 1), followed by the pixel at row 2, column 1 (2, 1), and so on until the last available row.

In the invention, the Identity Block is encoded into the image by overwriting the unpacked ordered list of pixels described above. Once overwritten, the image is then reencoded into one of the industry standard formats. Column ordering will display the embedded text message along the left edge of the image; row ordering will display it along the top edge of the image. The unused remainder of the image is untouched.

While certain examples and details of a preferred embodiment have been disclosed, it will be recognized by those skilled in the are that variations in implementation such as use of different programming methodologies, computing platforms, and processing technologies, may be adopted without departing from the spirit and scope of the present invention. Therefore, the scope of the invention should be determined by the following claims.

1. A method for recognizing parties with whom a user or system has established a trusted relationship by utilizing a computerized database to match public keys. The database will record contain information about trusted relationships, which may include but is not limited to, public key of a trusted party, public and private key of this user or system in the trusted relationship, domain name of a trusted party, and other information that may be pertinent to a trusted relationship.

2. A method for creating, storing and extracting embedded text, electronic signatures, and public keys and/or certificates encoded into a graphical image, including but not limited to any and all of the following, a digital certificate or public key, the electronic signature of a document, the electronic signature of the graphical image, and any additional information deemed necessary by the party or agent creating the image.

3. A method utilizing the graphical image defined in claim 2 for extracting the public key or certificate stored in the graphical image and for detecting whether the key belongs to a trusted party in the trusted party database as defined in claim 1.

4. A method for using drag-and-drop user action to extract the public key or certificate stored in the graphical as defined in claim 3 comprising of the steps: (a) drag-and-drop a document or graphical image to the Trusted Keys database; (b) verifying the signatures in the graphic image; (c) extracting the public key or certificate to determine if it belongs to a trusted party in the database; and (d) at the user's option, establishing a secure connection using any standard protocol that accepts certificates or public/private keys and does not require account names and passwords to authenticate the user or server.
